(19) United States
(12) Patent Application Publication
(10) Pub. No.: US 2007/0239537 A1
(43) Pub. Date: Oct. 11, 2007

(54) Advertisement brokerage system for diversified general media

(75) Inventors: Robert Llewellyn Protheroe, Naples, FL (US); John Arthur Moran, Fort Myers, FL (US); Craig A. Pisaris-Henderson, Fort Myers, FL (US); Anthony A. Garcia, Fort Myers, FL (US)

Correspondence Address: TIMOTHY P. O'HAGAN, 8710 KILKENNY CT, FORT MYERS, FL, 33912, US

(73) Assignee: MIVA, Inc., Fort Myers, FL (US)

(21) Appl. No.: 11/400,469

(22) Filed: Apr. 7, 2006

(51) Int. Cl. G06Q 30/00

(52) U.S. Cl. 705/14

(57) ABSTRACT

An advertisement system provides an advertisement impression in response to each advertisement request received from each of a plurality of diverse general media advertisement delivery systems. The advertisement system comprises a placement database and a distribution object. The placement stores a plurality of instances of advertisement content, each in association with a subject matter category, rendering factors, and a financial parameter. The distribution object receives each advertisement request. Each advertisement request includes channel identifier and at least one query parameter. The distribution object returns an advertisement impression that includes an instance of advertisement content that: i) is stored in association with a subject matter category meeting selection criteria determined from the query parameters; ii) is stored in association with rendering factors that correspond to the rendering type parameters; and iii) is stored in association with a financial parameter meeting financial parameter selection criteria. The rendering parameters are one of rendering parameters included in the impression request and/or rendering type parameters associated with the channel identifier. The financial parameter defines an amount payable by the advertiser upon the occurrence of an assessment event associated with rendering the instance of advertisement content.

### TECHNICAL FIELD

The present invention relates generally to marketing and advertising distribution and more particularly relates to systems and method for brokering adverting in one or more types of diversified general media.

### BACKGROUND OF THE INVENTION

The Internet has quickly grown from an obscure resource for high level researchers to a ubiquitous resource having hundreds of millions of pages of document content which is accessible by millions of users.

Paid advertisement is a business model used by many Internet media content providers that provide web page content, web application services, and/or search engine results to consumer's without charge. More specifically, advertisements are typically placed on the top, sides, and/or bottom of the viewing area of a web page displaying media content.

These advertisements are generally square or rectangular boxes provided with some combination of graphics and/or text directed to the product or service being advertised. These advertisements usually include a “hyperlink” to a redirect URL. Users who yield to the advertisement's solicitation to “Click Here” are linked to the web site of the manufacturer of the product or service being advertised, or to some other web site which provides additional information about the product or service.

The most simple method for placement of advertisements within a web page is for the publisher to simply hard code an advertiser provided banner advertisement within the HTML web page. When a client system establishes an HTTP session to the publisher's web server, the returned web page includes both the web page document content and the embedded banner advertisement. When the banner advertisement is hard coded, all viewers of the web page see the same banner advertisement.

An alternative dynamic system is disclosed in US Published Application 2004/0093327 to Anderson et al. Anderson et al. discloses a system wherein the web published media includes a “space” for an advertisement and, upon a client making a content request to the publisher's web server, the web server makes an advertisement request to an advertising system. The advertising system, which has analyzed the content of the published media, selects an advertisement relevant to the published media and returns the advertisement to the web server for placement within the available space. The web page that includes the dynamically placed advertisement embedded therein is returned to the client making the request. Again, the advertisement may include an active link to the advertiser's landing page which, if clicked by the viewer, will cause the client to be directed to the advertiser's landing page.

It has also been proposed to include advertisements in Internet distributed media content such as HTML email messages. In one example, US Published Application 2005/0076051 to Carobus et al. describes a system for serving content targeted ads in email.

The Carobus et al. system provides an HTML snippet for inclusion in each email sent by the publisher. The HTML snippet includes a URL of an advertising system. The URL is uniquely associated with the content that was previously made available to the Carobus et al. system. When a client email system opens the email, an advertisement request is made to a URL identified in the HTML snippet. In response to the advertisement request, the Carobus et al. system: i) looks up previously registered content; ii) builds and returns an advertisement image including one or more relevant advertisements.

In an alternative system described in U.S. patent application Ser. No. 11/236,460, filed on Sep. 27, 2005 and commonly assigned with the present patent application, the email includes a predetermined content request URL that includes an extension that includes a parameter that identifies a class of advertisements. When a client email system opens the email, an advertisement request is made to the predetermined content request URL. In response, the system returns one or more advertisements associated with the identified class.

In addition to supporting paid advertisement within such Internet based systems, proposals have been made for placement of paid advertisement content within static publications such as magazines and newspapers, or on dynamic displays such as electronic billboards. An example of such is described in U.S. patent application Ser. No. 10/331,926 entitled System and Method For Pay For Performance Advertising In General Media, filed on Dec. 30, 2002.

What is needed is a system and method for supporting paid advertisement through many diverse media. Further, what is needed is a system and method for providing the benefits of a paid advertising in multiple channels of general media—with diverse rendering formats, diverse consumer response capabilities, and diverse criteria for assessing the advertiser a charge for the advertising.

### SUMMARY OF THE INVENTION

A first aspect of the present invention comprises an advertisement system for providing an advertisement impression in response to each advertisement request received from each of a plurality of advertisement delivery systems. The advertising systems may be associated with diverse advertising media with diverse rendering formats, diverse consumer response capabilities, and diverse criteria for assessing the advertiser a charge for the advertising.

The advertisement system comprises a placement database and a distribution system coupled to the placement database. The placement database stores a plurality of instances of advertisement content. Each instance of advertisement content is stored in association with a subject matter category, rendering factors, and a financial parameter. The subject matter category may comprise a topical category and a plurality of nested sub categories within such topical category. Nested subcategories may subdivide a category based on: i) geographical locations of segments of the population to which the category is relevant, ii) time of day, time of month, season of year, or other temporal time segments; iii) demographic statistics of diverse segments of the population to which the category is relevant; and iv) and behavioral statistics of diverse segments of the population to which the category is relevant.

The distribution system receives each advertisement impression request and returns an advertisement impression. The advertisement impression request comprises a channel identifier and at least one query parameter.

The advertisement impression includes an instance of advertisement content that: i) is stored in association with a subject matter category meeting selection criteria determined from the query parameters; ii) is stored in association with rendering factors that correspond to the rendering type parameters, the rendering parameters being one of rendering parameters selected from a group of rendering parameters consisting of: i) rendering type parameters associated with, or implied by, the channel identifier; ii) rendering parameters included in the impression request; and ii) rendering parameters derived from the query parameters.

The financial parameter defines an amount payable by the advertiser upon the occurrence of an assessment event associated with rendering the instance of advertisement content.

Each instance of advertisement content may also be stored in association with a plurality of rendering factors. Such rendering factors may define a digital file format of the instance of advertisement content, a size and/or aspect ratio of a instance of advertisement content rendered as a static or motion video (with or without audio) advertisement, a duration of an instance of advertisement content rendered as audio or motion video (with or without audio), and other factors useful for selection of an advertisement compatible with a particular rendering media.

The advertisement system may further include a channel database associating rendering type parameters with each of a plurality of channel identifiers. The advertisement impression returned by the distribution object includes an instance of advertisement content that is stored in association with rendering factors that correspond to the rendering type parameters by looking up, in the channel database, the rendering type parameters stored in association with the channel identifier of the impression request.

Each instance of advertisement content may also be stored in association with response data. The response data defines a manner in which a consumer is to respond to the instance of advertisement content. For example, but not limitation, response data may define a URL to a landing page of the advertisers web sit such that consumer response is by clicking an active link within the advertisement for redirect to such URL; ii) response data may define a telephone number associated with a call center of the advertiser such that consumer response by telephone leads to a PSTN connection to the call center; iii) response data may be embodied in directions to the advertiser's establishment such that consumer response is by going to such advertiser's establishment or iv) response data may be embodied in a response object printable as a coupon such that consumer response is by use of the coupon in a transaction.

The advertisement impression returned by the distribution object includes an instance of advertisement content and response instructions which: i) are compatible with an advertisement rendering media associated with the channel identifier; and ii) direct consumer response to the instance of advertisement content as defined by the response data.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWINGS

FIG. 1 is a simplified block diagram of a system for practicing one embodiment of the present method of distributing advertisement for diversified advertisement media rendering;

FIG. 2 is a table representing classification of diversified advertisement media in accordance with one embodiment of the present invention;

FIG. 3 is a flow chart representing exemplary operation of a system for providing an advertisement impression in response to an impression request in accordance with one embodiment of the present invention;

FIG. 4 is a representation of a channel database in accordance with one embodiment of the present invention;

FIG. 5 is a representation of a placement database in accordance with one embodiment of the present invention;

FIG. 6 is a representation of a financial parameters in accordance with one embodiment of the present invention;

FIG. 7 is a representation of an advertisement database in accordance with one embodiment of the present invention;

FIG. 8 is a block diagram representing exemplary operating of the present invention for an exemplary class of advertisement media.

FIG. 9 is a block diagram representing exemplary operating of the present invention for an exemplary class of advertisement media.

FIG. 10 is a block diagram representing exemplary operating of the present invention for an exemplary class of advertisement media.

FIG. 11 is a block diagram representing exemplary operating of the present invention for an exemplary class of advertisement media.

FIG. 12 is an example of an advertisement impression applicable for rendering through a non-interactive media in accordance with one embodiment of the present invention;

FIG. 13 is an example of an advertisement impression applicable for rendering through an interactive media in accordance with one embodiment of the present invention;

FIG. 14 is an example of an advertisement impression applicable for rendering through a non-interactive interactive media in accordance with one embodiment of the present invention;

FIG. 15 represents rendering of an advertisement impression on a navigation system of a vehicle in accordance with one embodiment of the present invention;

FIG. 16 represents rendering of an advertisement impression embodied as a coupon in accordance with one embodiment of the present invention;

FIG. 17 represent rendering of an advertisement impression on a display of a mobile device in accordance with one embodiment of the present invention

FIG. 18 represents embodiment of an exemplary impression request as a universal resource locator in accordance with one embodiment of the present invention;

FIG. 19 represents embodiment of an exemplary impression request as a soap message in accordance with one embodiment of the present invention;

FIG. 20 is a block diagram representing components for obtaining and/or auto rendering instances of advertisement content in accordance with one embodiment of the present invention;

FIG. 21 is a flow chart representing exemplary operation of one aspect of operation of an auto rendering object in accordance with one embodiment of the present invention; and

FIG. 22 is a flow chart representing exemplary operation of one aspect of operation of an auto rendering object in accordance with one embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

It should also be appreciated that table structures represented in this application are exemplary only and intended to show the mapping of relationships between various data elements. Other table structures may store similar data elements in a manner that maintains the relationships useful for the practice of the present invention.

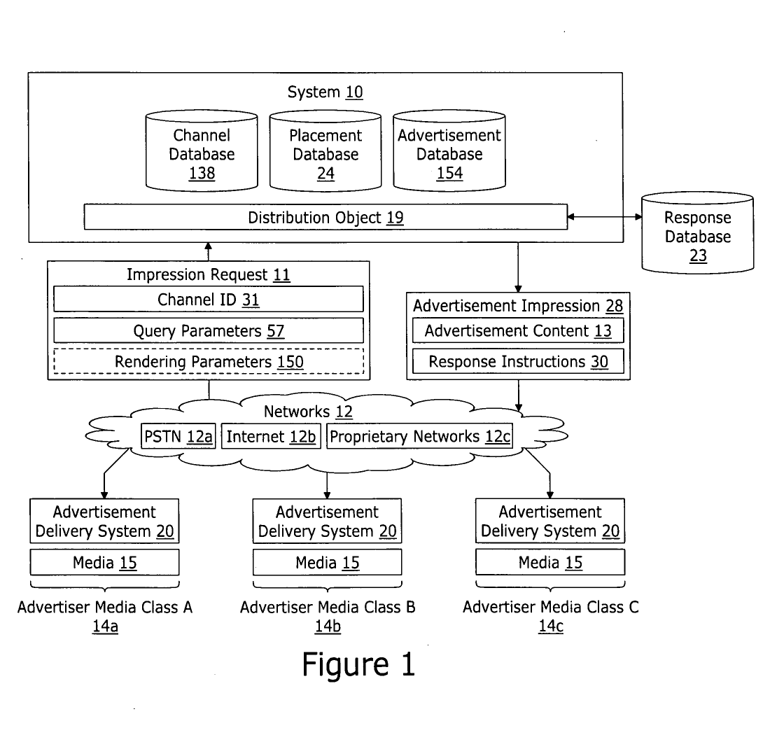

Referring to FIG. 1 an advertising system 10 is communicatively coupled to at least one of a plurality of networks 12 for: i) receiving advertisement impression requests 11 from each of a plurality of advertisement delivery systems 20; and ii) returning, in response to each advertisement impression request 11, an advertisement impression 28.

The networks 12 include the public switched telephone network (PSTN) 12a, the Internet 12b, and proprietary networks 12c. Those skilled in the art recognized that functions of PSTN network architecture and Internet network architecture are merging and for purposes of the present invention: i) the PSTN network 12a refers to applicable network architecture that enables initiation of a communication session by dialing of a telephone number; and ii) the Internet 12b refers to applicable network architecture that enables initiation of a TCP/IP or UDP/IP communication session by initiating a connection to an applicable IP address and port. Proprietary networks 12c refer to an architecture (which may include use of the Internet and/or PSTN) for the exchange of audio, graphic, and/or video data using proprietary protocols for either of session management and data exchange.

Each advertisement delivery systems 20 is associated with an advertisement media 15 in, on, or through which advertisement impressions 28 may be rendered in accordance with the present invention. For purposes of illustrating the present invention, the advertisement media 15 may be classified within three media channel categories or classes 14a-14c.

In U.S. patent application Ser. No. 10/331,926 (entitled System and Method For Pay For Performance Advertising in General Media, filed on Dec. 30, 2002, assigned to the same assignee as the present invention, and the contents of which is hereby incorporated by reference) the advertisement media are referred to as static, dynamic, and interactive general media distribution channels. For purposes of facilitating discussion of the present invention, the advertisement media are divided into three media channel categories or classes 14a-14c. It should be appreciated that classification is for purposes of facilitating discussion of exemplary embodiments only and those skilled in the art will understand that exemplary media providers could be classified in other classifications and other media providers not described in an exemplary embodiment may be within the scope of one or more described classifications or contain components.

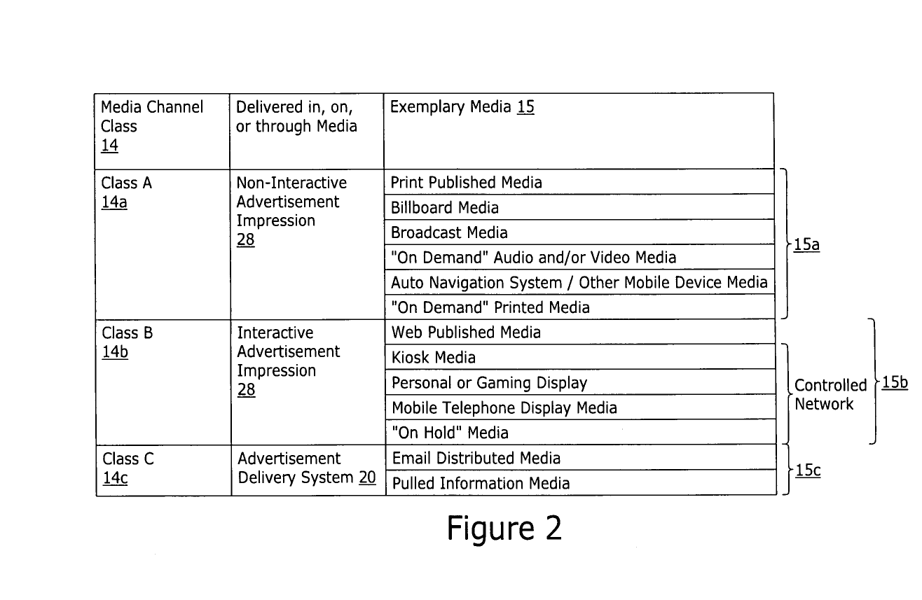

FIG. 2 is a table representing the exemplary types of advertisement media 15 within each class 14a-14c. In general, advertisement media 15 within Class A 14a are non-interactive (e.g. Class A media 15a) and advertisement impressions 28 rendered in such non-interactive Class A media 15a are in a non-interactive rendering format. Providers of Class A media 15a operate an advertisement delivery system 20 for generating an impression request 11 and receiving a non-interactive impression 28 for rendering in, on, or through the Class A media 15a.

A first subclass of class A media 15a comprises media wherein a single impression of the media 15a is distributed to, viewed by, listened to, and/or, otherwise perceived by multiple consumers. Examples of this first subclass include: i) printed publications wherein the original media impression (and any advertisement impressions 28 therein) is/are printed or copied without variation for distribution to a plurality of consumers; ii) billboards or other display media wherein the advertisement impression 28 rendered thereon (whether printed, digital image, or motion video) is viewed by multiple consumers; iii) broadcast media (e.g. radio, television, and other wireless or wired broadcasts or multicasts) wherein the broadcast signal or multicast content distributed represents a single impression of the media for rendering by multiple consumer rendering systems (e.g. television, radio, or other device for capturing and rendering of broadcast or multicast media); and iv) other similar media wherein the provider lacks the ability to generate a unique impression of media content for each of multiple consumers and the media lacks interactive capabilities due to either the media or the rendering system lacking interactive capabilities—or the media and the rendering system lacking compatible interactive capabilities.

A second subclass of Class A media 15a comprises media wherein an individual impression of non-interactive media is individually created “on demand” for rendering to a specific consumer. Examples of this second subclass of media include: i) non-interactive audio and/or video-on-demand media for rendering on non-interactive devices such as a television, iPod, or other audio and/or video rendering system; ii) printed “on demand” media such as coupons printed at a point of sale system; iii) media generated “on demand” and pushed to an automobile navigation system or a mobile telephone based on location and/or a consumer's information query; and iv) other media produced on an “on-demand” basis, personalized basis, or individually distributed basis wherein the media lacks the ability for the consumer to respond to an advertisement impression 28 through an interface of the rendering device due to either the media or the rendering system lacking interactive capabilities—or the media and the rendering system lacking compatible interactive capabilities.

In general, advertisement media 15 within Class B 14b are pushing interactive media (Class B media 15b) which push an interactive advertisement impression 28 for rendering on, or through, a consumer's rendering system. Providers of Class B media 15b operate an advertisement delivery system 20 for generating an impression request 11 and receiving an interactive impression 28 for rendering in, on, or through the Class B media 15b.

One example of a Class B media 15b includes web published media wherein a web server provides an interactive web document (e.g. HTML) with an interactive advertisement impression 28 to each consumer system (e.g. browser) establishing a connection therewith.

Another example of Class B advertisement media 15b includes interactive media pushed by a media provider that controls and/or limits network connectivity and/or controls and/or limits media flows to the rendering device. Examples of this type of advertisement media 15b include: i) interactive kiosk media (for example media provided through interactive kiosks publicly available for providing information to consumers); ii) interactive personal display media (for example media provided through interactive entertainment systems used for airline entertainment systems); iii) “on-hold” media (for example media provided by an interactive voice response (IVR) system to a caller “on hold”); and iv) interactive media provided to any compatible interactive rendering device such as a mobile telephone or PDA operating under control of a network service provider that controls and/or limits network connectivity and/or control and/or limits media rendered through such device.

In general, advertisement media 15 within Class C 14c are pulling interactive media (Class C media 15c) which drive a rendering system to pull an interactive advertisement impression 28. Unlike providers of Class B media 15b which operate an advertisement delivery system 20 to obtain an advertisement impression for delivery to a rendering system, providers of Class C media 15c provide an advertisement delivery system 20 to the rendering systems which operates on the rendering system to pull interactive advertisement impressions 28 by generating an impression request 11 and receiving an advertisement impression 28 in response thereto.

One example of Class C media 15c includes an email newsletter wherein the email newsletter includes an embedded advertisement delivery system 20 which generates an impression request 11 to the system 10 and receives an interactive impression 28 in response thereto when the consumer “opens” the email. In this example, the advertisement delivery system 20 is embodied in Java, Active X, or other script instructions which drive the email client, web browser, or email/browser “plug-ins” to generate the impression request 11 and render the returned interactive advertisement impression 28.

Another example of Class C media 15c includes a tool bar application or other application running in the background on a consumer's computer system. Such application may include an advertisement delivery system 20 which: i) periodically generates an impression request 11 and receives an interactive advertisement impression 28 in response thereto; and ii) renders such interactive advertisement impression 28 on the consumer's computer system. Typically such application will provide functionality and/or information content independent of its advertisement delivery/rendering functions.

Returning to FIG. 1, in the exemplary embodiment, each impression request 11 from an advertisement delivery system 20 includes a channel ID 31, query parameters 57, and optionally, rendering parameters 150.

A distribution object 19 of the system 10 returns an advertisement impression 28 that includes advertisement content 13 that: i) corresponds to an advertisement category meeting selection criteria determined from the query parameters 57 of the impression request 11; ii) is of a rendering type that corresponds to the rendering type parameters 150 of the impression request 11 and/or the rendering type parameters 150 associated with the channel identifier 31; iii) enables consumer response in a manner compatible with the media 15 in, on, or through which the advertisement impression 28 is to be rendered; and iv) is associated with a financial parameter meeting financial parameter selection criteria.

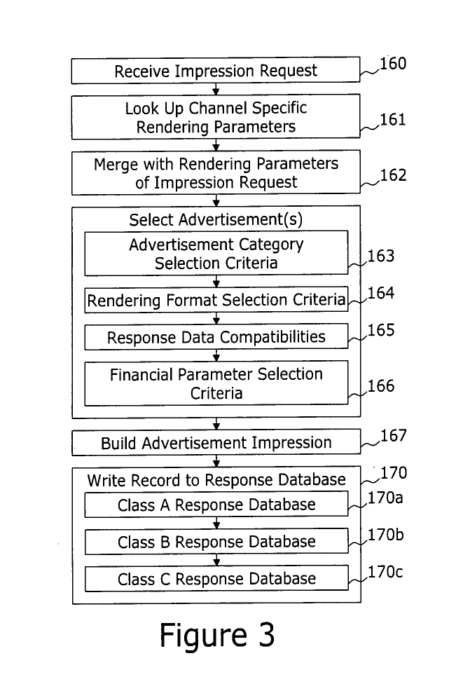

The flow chart of FIG. 3 represents exemplary steps performed by the distribution object 19. Referring to FIG. 3 in conjunction with FIG. 1, step 160 represents receipt of an impression request 11 from an advertisement delivery system 20.

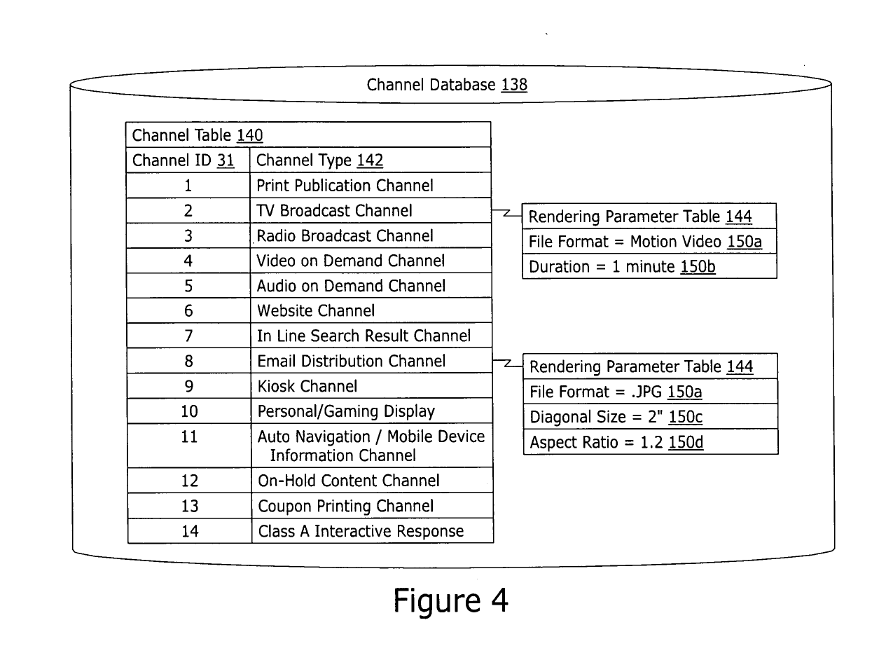

Step 161 represents looking up channel specific rendering parameters 150 from a channel database 138. Referring briefly of FIG. 4 in conjunction with FIG. 1, an exemplary channel database 138 includes a table structure for associating rendering parameters 150 with each channel ID 31. In an exemplary structure, a channel table 140 lists each channel ID 31 that may be received in an impression request 22. Associated with such channel ID 31 is an indication of the channel type 142 and a rendering parameter table 144.

The rendering parameter table 144 stores rendering parameters 150 which define how the instance of advertisement content 13 can be rendered in, by, or through the media associated with the channel ID 31. Stated another way, the rendering parameters 150 define the rendering capabilities of the channel. For example, if the channel ID 31 corresponds to a television broadcast channel, applicable rendering parameters 150 may specify a TV commercial quality non-interactive motion video file format as a file format parameter 150a and may specify a desired duration, or range of durations, of the commercial as a duration parameter 150b.

If the channel ID 31 corresponds to an email distribution channel, applicable rendering parameters 150 may specify a digital graphic file type (such as .jpg) as a file format parameter 150a, a desired diagonal image size (or range) as a diagonal size parameter 150c; and a desired aspect ratio (or range) as an aspect ratio parameter 150d.

Returning to FIG. 3 in conjunction with FIG. 1, step 162 represents merging any rendering parameters 150 included in the impression request 11 with rendering parameters 150 obtained from the rendering parameter table 144 associated with the channel ID 31 in the channel database 138.

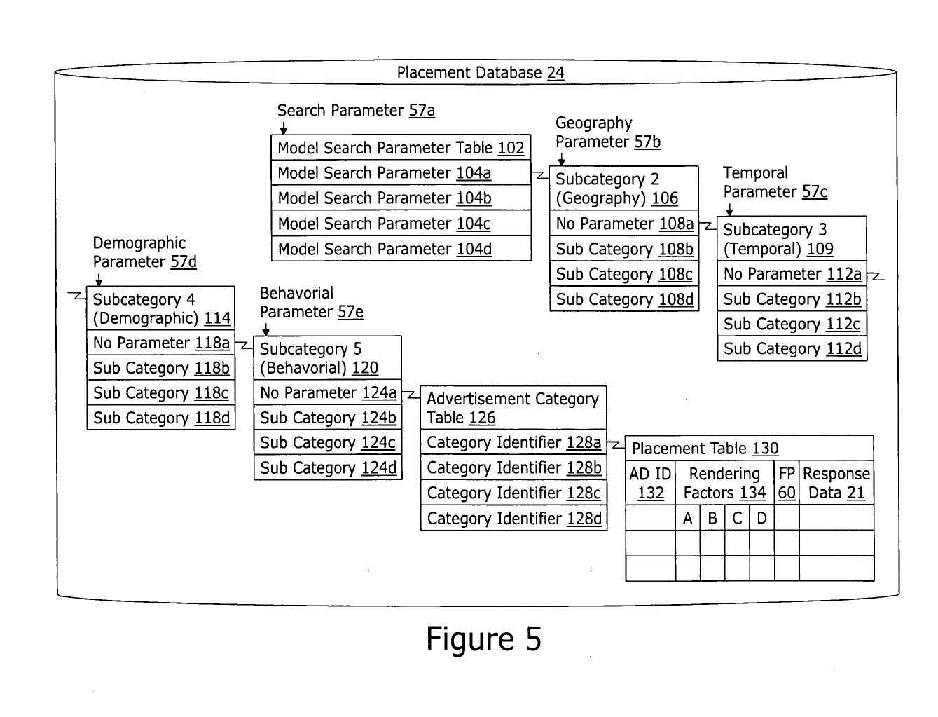

Further, step 162 may represent deriving additional rendering parameters from query parameters 57 included in the impression request 11. Such derived rending parameters may provide for selection of an instance of advertisement content 13 for rendering that can be rendered by the media (e.g. is within the rendering capabilities of the channel) and is expected to be more persuasive on a consumer based on certain query parameters 57. For example, an impression request 11 may include a rendering parameter that specifies a time duration range for a TV commercial and query parameters 57 (as discussed with respect to FIG. 5) may be used to derive additional rendering parameters which, for example, narrow the time duration range. As another example, an impression request 11 may include a rendering parameter that specifies an advertisement of a certain diagonal size and aspect ratio—for example for display of an advertisement on a web page. Query parameters 57 (such as a demographic parameter 57a (such as age) or a behavioral parameter 57e (such as past response behaviors) may be used to derive additional rendering parameters which, for example, drive selection of a text advertisement for one person and a graphic advertisement for another person.

Step 163 represents identifying those instances of advertisement content to which the consumer is likely to respond. More specifically, the system 10 searches a placement database 24 to identify those instances of advertisement content which corresponds to all query parameters 57 included in the impression request 11.

The diagram of FIG. 5 represents an exemplary structure of the placement database 24. It should be appreciated that there are many database structures and many searching techniques to facilitate locating a record that relates to multiple query parameters. The nested table structure represented by the diagram of FIG. 5 is for purposes of illustrating one such technique and is not intended to limit the scope of the invention.

The placemat database 24 includes nested levels of model query parameter tables 102, 106, 109, 114, and 120—each of which correspond to a query parameter 57 which may be included in an impression request 11. The exemplary query parameters 57 include, but are not limited, to parameters such as: a search parameter 57a; geography/location parameters 57b; a temporal parameters 57c, consumer demographic parameters 57d; and consumer behavior and/or historical activities parameters 57e.

The first table, or root table, of the placement database 24 is a model search parameter table 102. The model search parameter table 102 stores each of a plurality model search parameters 104. Each model search parameter 104 defines a topical category of advertisement content.

Each search parameter 57a may be a word, phrase, or other parameter that associates with a market and/or a potential need of the consumer to which the instance advertisement content 13 will for rendered.

For example, for Class A media 15a, the search parameter 57a may be a word, phrase, or other parameter that: i) associates with published or broadcast media 15 which with the advertisement impression will be delivered; ii) associates with subject matter likely to be of interest to potential viewers of a billboard or other display media; iii) associates with the “on demand” media with which the impression will be delivered; iv) associates with a search or query initiated by the consumer through his or her rendering device; or v) otherwise associates with a market and/or potential need of the consumer(s) to which the advertisement impression will be rendered.

For example, for Class B media 15b, the search parameter 57a may be a word, phrase, or other parameter that: i) associates with media 15 which with the advertisement impression will be delivered; ii) associates with a search or query initiated by the consumer through a rendering device; or iii) otherwise associates with a market and/or potential need of the consumer(s) to which the advertisement impression will be rendered.

For example, for Class C media 15c, the search parameter 57a may be a word, phrase, or other parameter that: i) associates with media 15 which with the advertisement delivery system 20 is to be delivered; ii) associates with the type of information or services provided by the application in which the advertisement delivery system 20 is embodied; or iii) otherwise associates with a market and/or potential need of the consumer(s) to which the advertisement impression will be rendered.

When a search parameter 57a is received as part of an advertisement request 11, it is mapped to a topically similar model search parameter 104 of the model search parameter table 102 for purposes of selecting a topical category that corresponds to such search parameter 57a.

Associated with each model search parameter 104 (e.g. associated with each topical category) is a second level of model query parameter tables useful for subdividing such topical category based on another query parameter. In the example of FIG. 5, the second level of model query parameter tables includes a model geographical parameter table 106.

When a geographically parameter 57b is received as part of an impression request 11, it is mapped to a corresponding model geography parameter 108 to select a subcategory of advertisement content which may be useful to the consumer or to which the consumer is likely to respond based on geography.

For example, each model geography parameter 108 may be a zip code. In which case, a geography parameter 57b, whether a zip code or other geographical location, may be mapped to those corresponding zip codes.

It should also be appreciated that one geographical subcategory 108a is a sub category of advertisement content which may be useful to the consumer or to which the consumer is likely to respond in a situation wherein the impression request 11 includes no geography parameter 57b. This subcategory 108a may encompass all subcategories 108.

Associated with each model geography parameter 108 is a third level of model query parameter tables useful for further subdividing based on another query parameter. In the example of FIG. 5, the third level of model query parameter tables includes a model temporal parameter table 109.

When a temporal parameter 57c is received as part of an impression request 11, it is mapped to a corresponding model date/time parameter 112 to select a subcategory of advertisement content which may be useful to the consumer or to which the consumer is likely to respond based on timing of the rendering.

For example, each model temporal parameter 112 may be associated with a time of day, week, month, or season of the year. In which case, a temporal parameter 57c, whether a time of day, time of week, time of month, time of year, or other temporal indicator (such as simply an indication to apply a time of day, week, month, season, or year as measured by the distribution object), may be mapped to a corresponding model temporal parameter 112.

Again, it should also be appreciated that one temporal subcategory 112a is a sub category of advertisement content which may be useful to the consumer or to which the consumer is likely to respond in a situation wherein the impression request includes no temporal parameter 57c.

Associated with each model temporal parameter 112 is a fourth level of model query parameter tables useful for further subdividing based on another query parameter. In the example of FIG. 5, the fourth level of model query parameter tables includes a model demographic parameter table 114.

When a demographic parameter 57d is received as part of an impression request 11, it is mapped to a corresponding model demographic parameter 118 to define a subcategory of advertisement content which may be useful to the consumer or to which the consumer is likely to respond based on a demographic parameter.

Again, it should also be appreciated that one demographic subcategory 118a is a sub category of advertisement content which may be useful to the consumer or to which the consumer is likely to respond in a situation wherein the impression request does not include the applicable demographic parameter 57d.

Associated with each model demographic parameter 118 is a fifth level of model query parameter tables useful for further subdividing based on another query parameter. In the example of FIG. 5, the fifth level of model query parameter tables includes a model behavioral parameter table 120.

When a behavioral parameter 57e is received as part of an impression request 11, it is mapped to a corresponding model behavioral parameter 124 to select a subcategory of advertisement content which may be useful to the consumer or to which the consumer is likely to respond based on such behavioral parameter.

Again, it should also be appreciated that one behavioral subcategory 124a is a sub category of advertisement content which may be useful to the consumer or to which the consumer is likely to respond in a situation wherein the impression request does not include the applicable behavioral parameter 57e.

This nested structure of subdividing each topical category based on each query parameter 57 is repeated for each query parameter 57 included in the impression request 112. Associated with the final subcategory, in this example the subcategory defined by the model behavioral parameter 124 is an advertisement category table 126.

The advertisement categories 128 listed in the advertisement category table 126: i) associate with such each query parameter 57 included in the impression request 11; and ii) define those advertisement subject matter categories 128 that meet such advertisement category selection criteria.

Associated with each advertisement subject matter category 128 is a placement table 130. Each record of the placement table represents an instance of advertisement content (identified by an advertisement ID 132) that is within such advertisement subject matter category 128.

As such, the result of applying each query parameter 57 to the placement database 24 is to identify a plurality of instances of advertisement content 13 that meet advertisement category selection criteria by nature of being represented by records in one or more placement tables 130 which link to the advertisement subject matter categories 128 that correspond to all query parameters 57 included in the impression request 11.

Step 164 represents identifying advertisement content 13, from those instances of advertisement content 13 meeting the advertisement category selecting criteria at step 163, those instances that are associated with rendering factors 134 that correspond to the rendering type parameters 150 of the impression request 11 and/or the rendering type parameters 150 associated with the channel identifier 31 in the channel database 138 (e.g. rendering format selection criteria).

More specifically, the placement table 130 associates rendering factors 134 with each advertisement ID 132. Rendering factors 134 may identify, with respect to the instance of advertisement content 13; i) its file format; ii) a size; iii) an aspect ratio, iv) a rendering duration; and other factors suitable for determining whether the content 13 would be applicable for rendering in, on, or through a particular media 15. At step 164, the system 10 selects those records of the placement table 130 wherein its rendering factors 134 correspond to the rendering parameters of the impression request 11 and/or the channel identifier 31.

Step 165 represents identifying, from those instances of advertisement content meeting both the advertisement category selection criteria at step 163 and the rendering format selection criteria at step 164, those instances of advertisement content 13 which enable consumer response in a matter compatible with the media 15.

More specifically, the placement table 130 associates response data 21 with each advertisement ID 132. The response data 21 defines how a consumer is to respond to the advertisement impression. For example, the response data 21 may include: i) a URL of a landing page of an advertiser's web site and to which a responding consumer is to be directed; ii) a telephone number of a call center of the advertiser to which a responding consumer is to be directed; iii) a geographical location of the advertiser to which a responding consumer is to be directed; iv) a response object (such as the coupon) which is to display and/or print for implicitly directing consumer response; or v) other response object for display and further direction of consumer response.

It should be appreciated that certain forms of response data 21 are applicable, and certain forms are inapplicable, to each of the diverse media 15 discussed with respect to FIG. 2. Step 165 represents the system 10 identifying those instances that are associated with response data 21 that is compatible with the channel media 15 (as determined by the channel ID 31) in, on, or through which the advertisement impression 28 is to be rendered.

Step 166 represents selecting advertisement content, from those instances of advertisement content meeting the advertisement category selection criteria at step 163, meeting the rendering format selection criteria at step 164, and being associated with response data 21 compatible with the media 15 at step 165, that are associated with a financial parameter meeting financial parameter selection criteria.

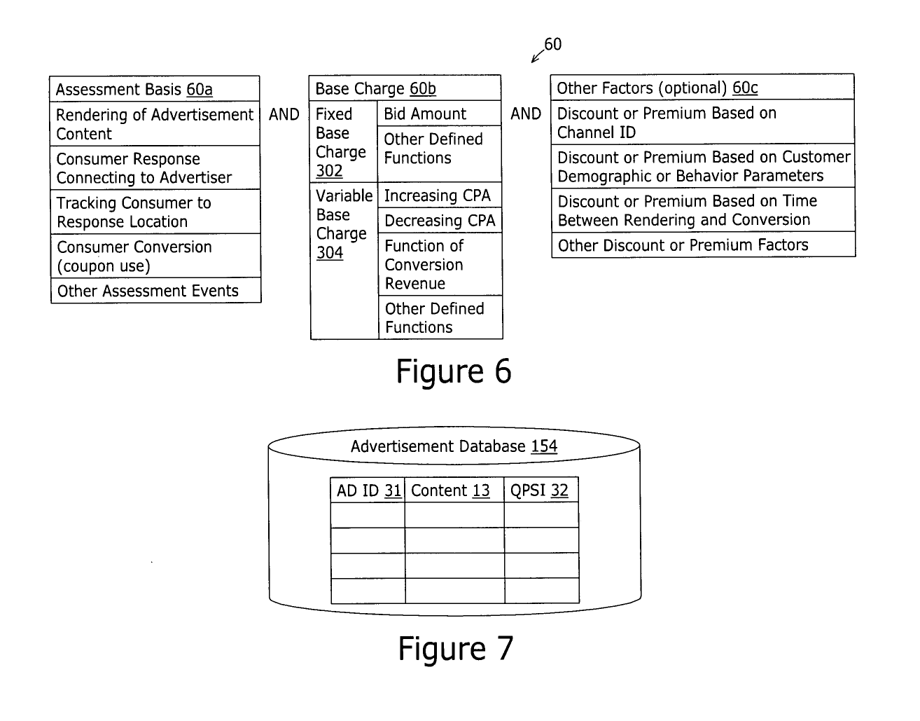

Turning briefly of FIG. 6, the financial parameter 60 may comprise such parameters as an assessment basis 60a, a base charge 60b, and other financial factors 60c for providing a basis for determining a charge assessable to the advertiser upon the occurrence of an assessment event related to the instance of advertisement content.

The assessment basis 60a defines the event triggering assessment of the charge to the advertiser. Exemplary assessment events include: i) rendering of the instance of advertisement content; ii) consumer response to the advertisement content (for example clicking on an advertisement impression and linking to the advertiser's web page); iii) consumer response by entering into a transaction to purchase goods or services from the advertiser and such transaction is linked to consumer response to the advertisement (e.g. commonly called conversion); and iv) other assessment events related to the rendering of the instance of the advertisement content or the consumer taking action in response thereto.

The base charge 60b may be either a fixed base charge 302, a variable base charge 304, or information useful for looking up, calculating, or otherwise determining a fixed base charge 302, a variable base charge 304 other base compensation scheme.

Examples of a fixed base charge 302 include: i) a bid amount associated with an instance of advertisement content—which may be different for different format renderings (or multiple format renderings) of what would otherwise be the same advertisement; and ii) other functions in which the charge assessable to the advertiser is the same each time the assessment event occurs with respect to the same instance of advertisement content.

Examples of a variable charge 304 may include charges which are a function of: i) a charge which increases or decreases as a function of the number of times the instance of advertisement content is rendered, ii) which are based a function of conversion revenue (revenue on a commercial transaction that is a result of consumer response to the instance of advertisement content); or iii) other functions in which the charge assessable to the advertiser may be different each time the assessment event occurs with respect to the same instance of advertisement content.

Exemplary other factors 60c are functions useful for altering the assessment charge based on factors relevant to the advertisement. Examples include: i) functions for discounting or providing a premium based on delivery of the instance of advertisement content through a particular media 15; ii) functions for discounting or providing a premium based on delivery of the instance of advertisement content for rendering based on customer demographics and/or behavior patterns (based on query parameters 57); and iii) functions for discounting or providing a premium based other advertisement related factors (for example based on certain rendering parameters 150).

The financial selection criteria may specify selecting the instance of advertisement content 13 having a favorable financial parameter 60, for example the highest assessable amount (or estimated or predicted highest assessable amount) based the base charge 60a, assessment basis 60b, and/or other factors 60c.

In another example, the financial selection criteria may specify selecting, on a rotating basis, one of a plurality of instances of advertisement content 13. U.S. patent application Ser. No. 10/724,546 filed on Aug. 19, 2004 and commonly assigned with the present application describes systems and methods for selecting one of a plurality of instances of advertisement content. The contents of such application is incorporated herein.

Returning to FIG. 3 in conjunction with FIG. 1, step 167 represents building an advertisement impression 28 for return to the advertisement delivery system 20. More specifically, after identifying one or more records of one or more placement tables at steps 163-166, the system 10 retrieves the advertisement content 13 for inclusion in the advertisement impression 28.

Turning briefly to FIG. 7 in conjunction with FIG. 5, an advertisement database 154 stores the advertisement content 13 that is associated with each advertisement ID 132. The advertisement database may also store query parameter solicitation instructions (QPSI) 32 with each instance of advertisement content 13. The QPSI 32 and their function are discussed in more detail with respect to various exemplary embodiments of operation of the present invention.

Returning again to FIG. 3 in conjunction with FIG. 1, the system 10 further retrieves the response data 21 associated with the advertisement ID 132 and builds response instructions 30 for inclusion in the advertisement impression 28. Exemplary response instructions 30 are discussed in more detail with respect to various exemplary embodiments of operation of the present invention.

Step 170 represents writing a record to the response database 23 if applicable. The information written to each record of the response database is discussed in more detail with respect to various exemplary embodiments of operation of the present invention.

Class A Operation

As discussed, Class A media 15a is non-interactive media. There are two exemplary embodiments of operation of the present invention for delivery of advertisement content for rendering in, on, or through Class A media.

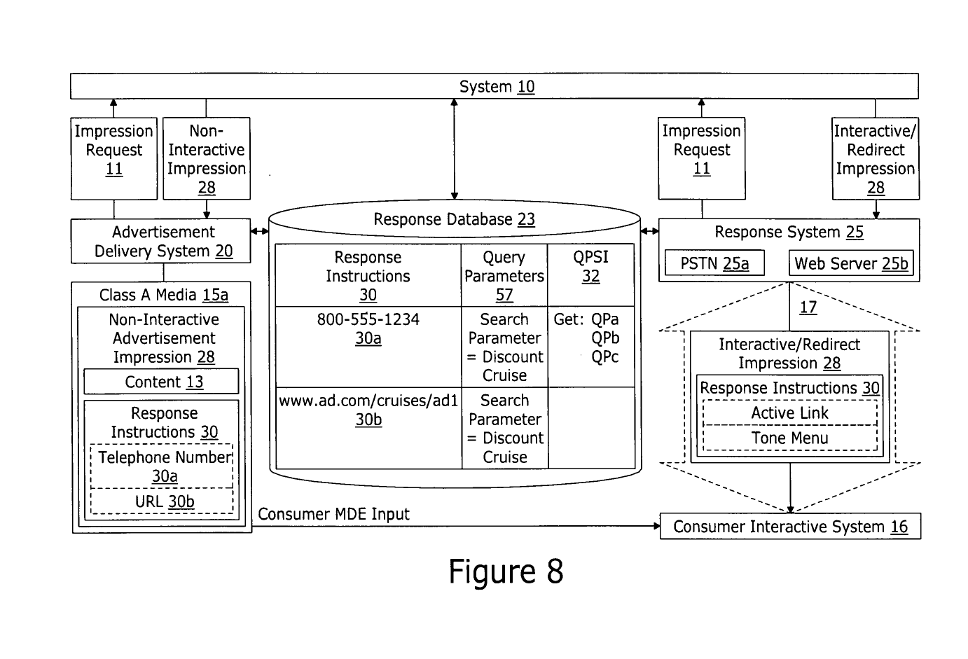

A first embodiment, represented by FIG. 8, is useful wherein a single impression is rendered to multiple consumers by way of publication, broadcast, multicast, or display.

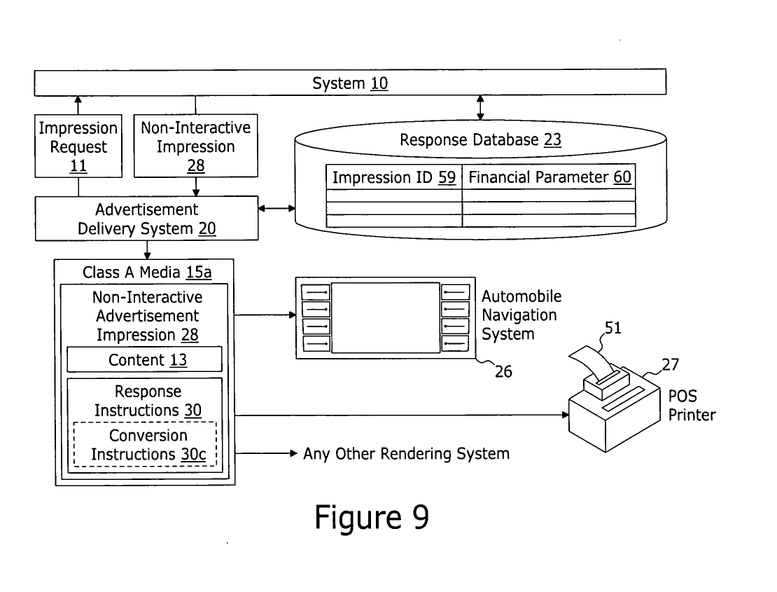

A second embodiment, represented by FIG. 9 is useful wherein an impression is created “on demand” for rendering to a specific consumer.

Referring to FIG. 8 in conjunction with FIG. 1, an advertisement delivery system 20 makes an impression request 11 to the system 10 to obtain a non-interactive impression 28 for rendering in, on, or through the Class A media 15a.

As discussed, the impression request 11 includes a channel identifier 31, query parameters 57 and, optionally, rendering parameters 150.

In an example wherein the impression request 11 is to obtain an advertisement impression for rendering in published media such as a newspaper or magazine, exemplary query parameters 57 may identify advertisement subject matter categories that appeal to typical readers of the publication—such as subject matter of the publication, subject matter of the article in which the advertisement impression 28 will be printed, geographic locations of distribution of the publication, and/or timing of distribution of the publication. Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In an example wherein the impression request 11 is to obtain an advertisement impression 28 for rendering on an electronic bill board, exemplary query parameters 57 may identify advertisement subject matter categories that appeal to potential viewers of the billboard—such as location of the billboard, the time frame during which the advertisement will be displayed, and/or the subject matter of events occurring geographically close to the billboard. Exemplary rendering parameters may identify a required size and/or aspect ratio of the advertisement impression or identify other rendering parameters.

In an example wherein the impression request 11 is to obtain an advertisement impression for rendering as an audio or audio/video commercial in a broadcast, exemplary query parameters 57 may identify, advertisement subject matter categories that appeal to consumers who will be listening to and/or watching the broadcast at the time of the commercial—such as subject matter of entertainment content in which the commercial will be placed, geographic locations in which the commercial will be broadcast, and/or timing of the rendering of the commercial. Rendering parameters may include a required time duration for the commercial.

As discussed, the system 10 will return an advertisement impression 28 that includes an instance of advertisement content 13 that: i) corresponds to an advertisement subject matter category meeting advertisement category selection criteria determined from the query parameters 57; ii) is of a rendering type that corresponds to the rendering type parameters 150 of the impression request 11 and the rendering type parameters 150 associated with the channel identifier 31; iii) is associated with response data 21 compatible with the media channel in, on, or through which the advertisement impression is to be rendered; and iv) is associated with a financial parameter meeting financial parameter selection criteria. The advertisement impression 28 will also include response instructions 30 which are compatible with the media 15a and direct consumer response to the advertisement content as defined by the response data 21 associated therewith.

In the example of a non-interactive advertisement impression 28, the response instructions 30 may be in the form of a telephone number 30a and/or a URL 30b associated with a response system 25.

The consumer responds to the advertisement content 13 using a consumer interactive system 16 to establishing a response connection 17 to the response system 25. For example: i) the consumer may dial the telephone number 30a to establish a PSTN response connection 17 to a PSTN component 25a of the response system 25; or ii) the consumer may enter the URL 30b into a browser to establish an IP response connection 17 with a web server component 25b of the response system 25.

Upon the consumer establishing the response connection 17, the response system 25 makes an impression request 11 to the system 10 and receives an advertisement impression 28 in response thereto. The advertisement impression 28 may include an instance of advertisement content 13 for rendering to the consumer through the response connection 17. Alternatively, the advertisement impression 28 may be simply a redirection impression and include only response data—which as discussed in U.S. patent application Ser. No. 10/331,926 (discussed above) drives the response system 25 to immediately redirect the consumer to the advertiser—either by transferring the consumers PSTN telephone call to the advertiser or by redirecting the consumer's web browser to the advertiser's web server.

As previously discussed, the impression request 11 includes a channel identifier 31 and query parameters 57. However, the query parameters 57 of this request 11 must assure that the advertisement impression 28 returned to the response system 25 is related to the advertisement content 13 of the non-interactive advertisement impression 28 which prompted the consumer to establish the response connection 17.

As such, when the non-interactive advertisement impression 28 is generated, one of the system 10 and the advertisement delivery system 20 may write a record to the response database 23 as discussed with respect to step 170 of FIG. 3. In the example of this first embodiment of advertising through class A media 15a, the record associates query parameters 57 and query parameter solicitation instructions 32 that relate to the advertisement content 13 of the impression 28 delivered to the advertisement delivery system 20 with the telephone number 30a and the URL 30b set forth in the response instructions 30 of such impression 28.

When a consumer establishes a response connection 17, the response system 25 generates its impression request 11 by: i) looking up the query parameters 57 associated with the telephone number 30a or URL 30b on which the response connection 17 is received; ii) including these looked up query parameters 57 within the impression request 11; and iii) if appropriate, including within the impression request 11, one of a channel ID 31 and/or rendering parameters 150 which indicate its capabilities of rendering an advertisement impression 28 through the response connection 17.

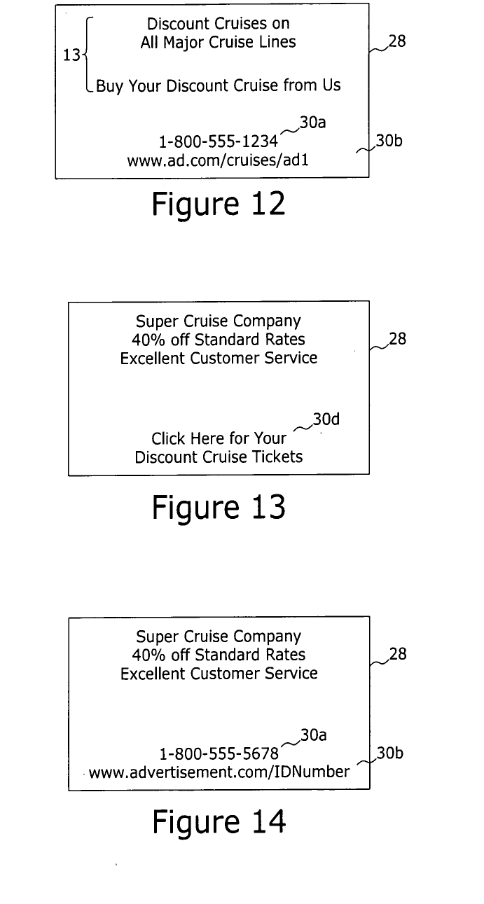

For example, referring briefly to FIG. 12 in conjunction with FIG. 8, the non-interactive advertisement impression 28 may be a general advertisement (referred to as a content descriptor in the U.S. patent application Ser. No. 10/331,926 referenced earlier) for a type of product or service provided by multiple potential advertisers. For example, the general advertisement may be for discount cruises, a product offered by multiple discount cruise ticket providers.

The response instructions 30 includes a unique telephone number 30a associated with the solicitation 28 and a unique URL 30b associated with the solicitation 28 to which the consumer is to make contact to either: i) receive an advertisement from one of the multiple discount cruise ticket providers; or ii) be directly connected to one of the multiple discount cruise ticket providers (e.g. by telephone or website). A search parameter 57a of “discount cruise” is written to the response database 23 in association with each of the telephone number 30a and the URL 30b.

When a consumer responds to the non-interactive advertisement impression 28 by entering, the URL 30b into a browser to establish the response connection 17 as an IP connection, the response system 25 generates its impression request 11 by: i) looking up the search parameter 57a (and other query parameters 57) associated with the URL on which the response connection 17 was established; ii) and using an channel ID 31 and/or rendering parameters 150 which indicate its ability to render web pages or similar interactive document content through the response connection 17.

As such, the system 10 provides an advertisement impression 28 which, as discussed, may include an instance of interactive advertisement content 13 for rendering to the consumer through the response connection 17 or be a redirection that drives the response system 25 to immediately redirect the consumer's web browser to the advertiser's web server.

If interactive advertisement content 13 is included for rendering through the response system such advertisement content 13: i) may be associated with a subject matter category semantically similar to “discount cruise” (and associated with any other query parameters 57 included in the request 11); ii) is of a rendering type that can be rendered through the response connection 17; iii) is associated with response data 21 compatible with rendering through the response connection 17; and iv) is associated with a financial parameter meeting financial parameter selection criteria.

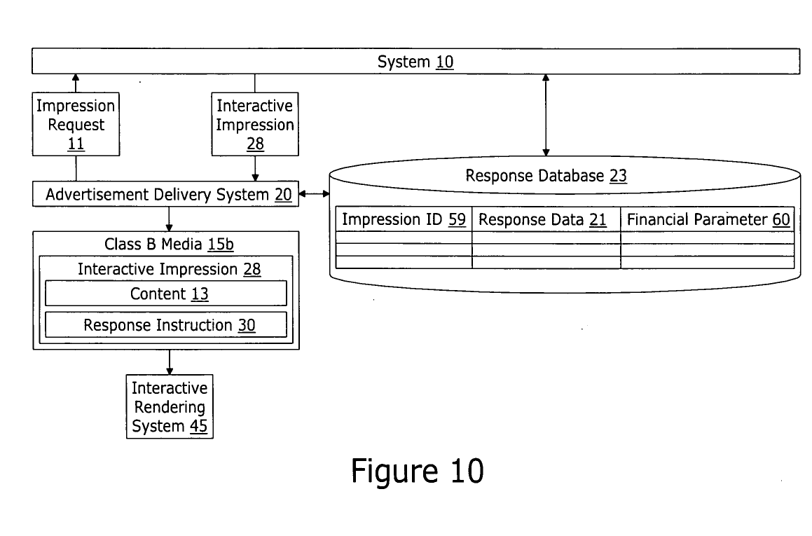

An interactive instance of advertisement content (an example of which is represented by FIG. 13) would include a response instruction 30 in the form of a hyperlink 30d to solicit consumer response by mouse click. Upon response, the consumer's browser may be linked to a landing page of the advertiser's web site as will be discussed in more detail with respect to FIG. 10. Additionally, other examples of response instructions with are compatible with an IP response connection 17 are discussed in more detail with respect to FIG. 10.

When a consumer responds to the non-interactive advertisement impression 28 by dialing the telephone number 30a to establish a PSTN response connection 17 with the PSTN component 25a of the response system 25, the response system 25 generates an impression request 11 by: i) looking up, in the response database 23, the search parameter 57a (and other query parameters 57) associated with the telephone number on which the PSTN response connection 17 was established; and ii) if appropriate, using a channel ID 31 and/or rendering parameters 150 which indicate its ability to render audio advertisements with interactive voice or DTMF menu response through the response connection 17.

As such, the system 10 provides an advertisement impression 28 which, as discussed, may include an instance of interactive advertisement content 13 for rendering to the consumer through the PSTN response connection 17 or be a redirection that drives the response system 25 to immediately transfer the consumer's PSTN response connection 17 to an advertiser.

If interactive advertisement content 13 is included for rendering through the PSTN response connection 17, such interactive advertisement content: i) may be associated with a subject matter category semantically similar to “discount cruise” (and associated with any other query parameters 57 included in the request 11); is of a rendering type that can be rendered through the PSTN response connection 17; iii) includes response instructions 30 which drive the PSTN component 25a of the response system 25 to establish a connection to the advertiser upon consumer response to the content 13 through the PSTN component 25a; and iv) is associated with a financial parameter meeting financial parameter selection criteria. The PSTN component 25 a may be an interactive voice response (IVR) system or DTMF tone recognition system.

It should also be appreciated that information about a specific consumer responding to a non-interactive advertisement impression 28 is unknown. Therefore to include additional parameters 57 related to the consumer's geography, demographics, behavior, or subject matter specific needs, the response system 25 may have the capability of running query parameter solicitation instructions 32 for obtaining, from the responding consumer through the response connection 17, additional consumer specific query parameters 57 for inclusion within the impression request 11.

Referring briefly back to FIG. 7, the advertisement database 154 may associate query parameter solicitation instructions 32 with instances of advertisement content 13. For example, briefly referring again to FIG. 12, the exemplary advertisement impression 13 for discount cruises may be associated with query parameter solicitation instructions 32 which are scripts for soliciting from the consumer, through the IP response connection 17, such query parameters as a price range for desired cruises, desired cruise destinations, information about past cruse experiences, and/or other information about the consumer and/or his or her cruising desires.

As discussed, these query parameter solicitation instructions 32 are also written to the response database 23 when the non-interactive impression 28 is returned to the delivery system 20. The response system 25 accesses the query parameter solicitation instructions 32 when the consumer establishes the response connection 17. The response system 25 executes such instructions 32 to obtain additional consumer specific query parameters 57.

With respect to this first embodiment of operation for non-interactive advertising, it should be appreciated that the non-interactive advertisement impression 28 may include advertisement content 13 for one particular provider (rather than a general advertisement). Such an example is represented by FIG. 14. In which case, the interactive impression 28 would also be specific to such one particular provider.

Further those skilled in the art will appreciate that in the embodiment wherein non-interactive advertisement impression 28 includes advertisement content 13 for a single provider, the response instructions 30 may include a telephone number 30a which links directly to the call center of the advertiser or a URL 30b that links directly to a landing page of the advertiser's web site thereby bypassing a need for the class A response system 25. However, use of the response system 25 has the benefit of tracking consumer response to the advertisement impression 28 and therefore, in the preferred embodiment, the telephone number 30a or the URL 30b will be for purposes of establishing a response connection 17 with the response system 25 and the response system 25 will link the response connection 17 to a call center or IVR system of an advertiser or link, or redirect, the consumer's browser to a landing page of an advertiser's web site.

In the second embodiment, represented by FIG. 9, each non interactive advertisement impression 28 rendered in the Class A media 15a includes advertisement content 13 and response instructions 30 which comprise a conversion instruction 30c. The consumer responds to the advertisement content 13 by acting on the conversion instructions 30c.

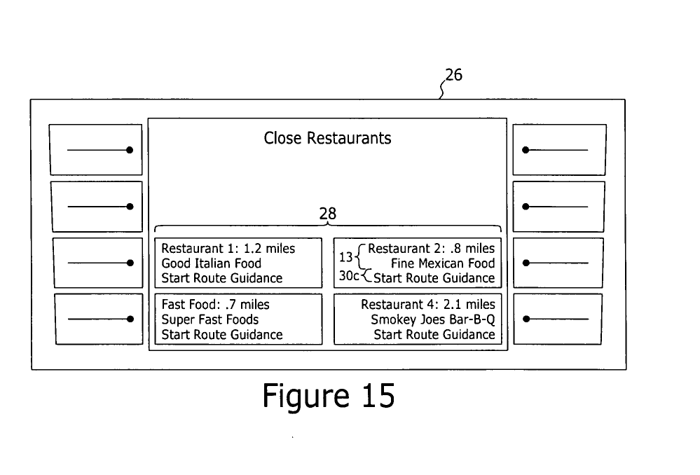

For example, non-interactive advertisement impressions 28 may be delivered to a networked automobile navigation system 26 for display thereon. Referring briefly to FIG. 15, each impression 28 may include advertising content 13 (for example content advertising a restaurant) and the conversion instructions 30c in the in the form of the location of the restaurant, directions to the restaurant, and/or other data to drive route guidance to the restaurant in response to the consumer initiating route guidance.

The consumer responds to the advertisement impression 28, if at all, but driving to the restaurant. Response (which may be an assessment event) may be tracked by monitoring the location of the vehicle through the networked automobile navigation system.

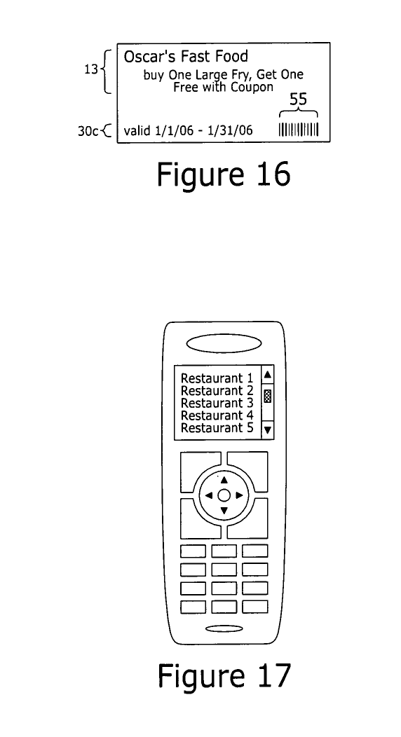

Returning to FIG. 9, as another example a non-interactive advertisement impressions 28 may be rendered as a coupon 51 (printed in a publication or printed by a POS printer 27). Referring briefly to FIG. 16, advertisement content 13 is embodied in the information presented on the coupon 51 and the conversion instructions 30c are express or implied instructions for use of the coupon. The consumer responds to the advertisement impression 28, if at all, by using the coupon to purchase goods or services. Response may be tracked by encoding a unique serial number 55 in the form of a barcode on each coupon. Use of the coupon may be an assessment event.

Returning to FIG. 9, an advertisement delivery system 20 makes an impression request 11 to the system 10 to obtain a non-interactive impression 28 for rendering in, on, or through the Class A media 15a. As discussed, the impression request 11 includes a channel identifier 31, query parameters 57 and, optionally, rendering parameters 150.

In an example wherein the impression request 11 is to obtain one or more instances of advertisement content 13 for rendering on an automobile navigation system, the exemplary query parameters 57 may identify the subject matter of a search or query initiated by the driver (for example restaurants, gas stations, or other categories of potential destinations), the vehicles current location, and optionally demographic or behavioral parameters known about the driver and maintained in a database by the provider of the navigation services. Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In an example wherein the impression request 11 is to obtain one or more instances of advertisement content 13 for rendering as coupons at a POS printer, the exemplary query parameters 57 may identify advertisement subject matter categories potentially useful to a consumer such as search parameters derived from items recently purchased by a consumer, and/demographic or behavioral parameters known about the consumer and maintained an a frequent shopper database. Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In an example wherein the impression request 11 is to obtain one or more instances of advertisement content 13 for rendering in published media such as a newspaper or magazine, exemplary query parameters 57 may identify advertisement subject matter categories that appeal to typical readers of the publication—such as subject matter of the publication, subject matter of the article in which the advertisement impression 28 will be printed, geographic locations of distribution of the publication, and/or timing of distribution of the publication. Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

As discussed, the system 10 will return an advertisement impression 28 that includes an instance of advertisement content 13 that: i) corresponds to an advertisement subject matter category meeting advertisement category selection criteria determined from the query parameters 57; ii) is of a rendering type that corresponds to the rendering type parameters 150 of the impression request 11 and the rendering type parameters 150 associated with the channel identifier 31; iii) is associated with response data 21 embodied as a conversion instruction 30c; and iv) is associated with a financial parameter meeting financial parameter selection criteria.

As previously discussed with respect to step 170 of FIG. 3, when the advertisement impression 28 is generated, the system 10 may write a record to the response database 23. In this second embodiment of operation for advertising in, on, or through Class A media 15a, such record may include an association between a unique ID number 59 assigned to the advertisement impression 28 and the financial parameter 60 associated with the content 13 at the time the impression is 28 is provided to the delivery system 20. This enables the appropriate financial parameter 60 to be assess to the advertiser upon subsequent consumer response to the advertisement impression 28. For example, if the advertisement impression 28 is rendered as a coupon 51 (FIG. 16), the unique ID number 59 may be the unique serial number 55 encoded on the coupon 51 such that when the coupon is used, the appropriate financial parameter may be assessed to the advertiser.

Class B

As discussed, class B media 15b is interactive media where an advertisement impression 28 is pushed for rendering through a rendering system. Typically, a provider of Class B media 15b generates an individual impression for each of multiple consumers. And, the advertisement content 13 included with each individual impression may be individually selected and vary from advertisement content 13 included with other impressions.

Exemplary operation of the present invention for rendering of advertisement in or through Class B media 15b is represented by the block diagram of FIG. 10. Prior to pushing the class B media 15b to an interactive rendering system 45, an advertisement delivery system 20 generates an impression request 11 to the system 10. As discussed, with respect to FIG. 1, the impression request includes query parameters 57, a channel identifier 31, and, optionally, rendering parameters 150.

In an example wherein the impression request 11 is to obtain one or more instances of advertisement content 13 for rendering within web published media, exemplary query parameters 57 may identify advertisement subject matter categories related to the web published media, identify words a consumer typed into a search engine object, identify demographic or behavioral parameters known about the user and captured by a cookie stored on a consumers computer, and/or other query parameters useful for selecting an advertisement subject matter category meeting advertisement category selection criteria.

Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In an example wherein the impression request 11 is to obtain one or more instances of advertisement content 13 for rendering within web published media, exemplary query parameters 57 may identify advertisement subject matter categories related to the content of web published media in which the advertisement impression will be embedded, identify words a consumer typed into a search engine object, identify demographic or behavioral parameters known about the user and captured by a cookie stored on a consumers computer, and/or other query parameters useful for selecting and advertisement subject matter category meeting advertisement category selection criteria.

Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In an example wherein the impression request 11 is to obtain one or more instances of advertisement content 13 for rendering within media pushed to a kiosk, such as a public information kiosk, exemplary query parameters 57 may identify advertisement subject matter categories related to the information content in which the advertisement impression will be rendered (whether such content is requested by a user or pushed to the kiosk by media flows controlled by a content server), identify a geographical location of the kiosk, identify providers located geographically close to the kiosk (for example if the kiosk is in a mall, identify stores close to the kiosk), identify demographic or behavioral parameters known about the user by basis of user log in or otherwise, and/or identify other query parameters useful for selecting and advertisement subject matter category meeting advertisement category selection criteria.

Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In an example wherein the impression request 11 is to obtain one or more instances of advertisement content 13 for rendering within media pushed to a personal display, for example the in-seat entertainment systems becoming popular on airlines, exemplary query parameters 57 may be parameters which identify advertisement subject matter categories related to the content in which the advertisement impression will be rendered (whether such content is requested by a user or pushed to the system by media flows controlled by a content server), identify the origin and/or destination of the flight, identify demographic or behavioral parameters known about the person sitting in the seat (based on frequent flyer account or other ticket purchasing information), and/or identify other query parameters useful for selecting and advertisement subject matter category meeting advertisement category selection criteria.

Again, exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In an example wherein the impression request 11 is to obtain one or more instances of advertisement content 13 for rendering on a mobile telephone display, exemplary query parameters 57 may be parameters which identify advertisement subject matter categories requested by the user (for example restaurants, gas stations, or other categories of potential destinations), the mobile telephone's current location, identify demographic or behavioral parameters known about user (based on mobile telephone service account information), and/or identify other query parameters useful for selecting and advertisement subject matter category meeting advertisement category selection criteria.

In an example wherein the impression request 11 is to obtain one or more instances of advertisement content 13 for rendering through an IVR system to a caller “on-hold”, exemplary query parameters 57 may be parameters which identify advertisement subject matter categories related to the company called or the advertisement responded to by placing of the call, the location of the caller (based on caller ID), identify demographic or behavioral parameters known about the caller (whether based on caller ID, the caller's account at the company being called, or otherwise known), and/or identify other query parameters useful for selecting and advertisement subject matter category meeting advertisement category selection criteria. Exemplary rendering parameters 150 may identify a file format requirement (e.g. file format of a digital audio), and a duration of the digital audio file.

As discussed, the system 10 will return an advertisement impression 28 that includes an instance of advertisement content 13 that: i) corresponds to an advertisement subject matter category meeting advertisement category selection criteria determined from the query parameters 57; ii) is of a rendering type that corresponds to the rendering type parameters 150 of the impression request 11 and the rendering type parameters 150 associated with the channel identifier 31; iii) is associated with response data 21 embodied as a conversion instruction 30c; and iv) is associated with a financial parameter meeting financial parameter selection criteria.

After receiving the advertisement impression 28, the advertisement impression 28 is pushed for rendering by the interactive rendering system 45.

Referring briefly to FIG. 14, an example of an interactive advertising impression 28 useful for rendering within web page content, on a kiosk, a personal display, or any other device with web browser types of functionality is shown. The example advertisement impression 28 includes an advertiser specific advertisement for discount cruises. The response instructions 30 are in the form of a hypertext link 30d which, if clicked or otherwise activated, drives the interactive rendering system 45 to establish an IP connection or otherwise request information associated with the hypertext link 30d.

In an exemplary embodiment wherein the system 45 has unrestricted internet access, the URL of the hyperlink is to the system 10 which redirects the system 45 to a URL of the advertisers web site landing page. Although the hyperlink 30d could be directly to the landing page of the advertiser's web site, a redirect through the system 10 enables consumer response tracking.

In an exemplary embodiment wherein the system 45 does not have internet access or its media content is controlled by a content server (such as kiosks or entertainment systems), the URL of the hyperlink may be to a controlling system which operates as a proxy server for obtaining additional information to provide in response to consumer activation of the link 30d.

Referring briefly to FIG. 17, in an exemplary embodiment wherein the system 45 is a mobile telephone, the advertisement impressions 28 may all relate to a single subject matter request by the user—such as geographically close restaurants. In this example, like the navigation system discussed with respect to FIG. 15, the response instructions 30 may be contact instructions (e.g. a telephone number) or conversion instructions in the in the form of the location of the restaurant, directions to the restaurant, and/or other data to drive route guidance to the restaurant in response to the consumer initiating route guidance. The consumer may respond to the advertisement impression 28 by selecting the content to initiate a telephone call and/or obtain directions to the restaurant. Response, which may be contact or conversion, either of which may be an assessment event, may be tracked by monitoring the location of the mobile telephone within the service provider's network.

Returning to FIG. 10, in an example wherein the class B media 15b is telephone on-hold content, the impression 28 may be an audio advertisement impression rendered by an IVR system through the PSTN to the consumer's telephone (which operates as the interactive rendering system 45). In this example, the response instructions may be just an instruction to enter one or more DTMF tones to respond to the advertisement impression and, because the consumers telephone 46 is coupled to the media provider 14c, the response instructions 30 executed on the IVR system may connect the consumers PSTN session to a call center of the advertiser.

As previous discussed with respect to step 170 of FIG. 3, when the advertisement impression 28 is generated, the system 10 may write a record to the response database 23. In the example of advertising through class B media 15b, the record may associate a unique impression ID 59 (such as the unique response URL 30d included in the impression 28) with response data 21 and the financial parameter 60 effective at the time the impression 28 is rendered.

Class C

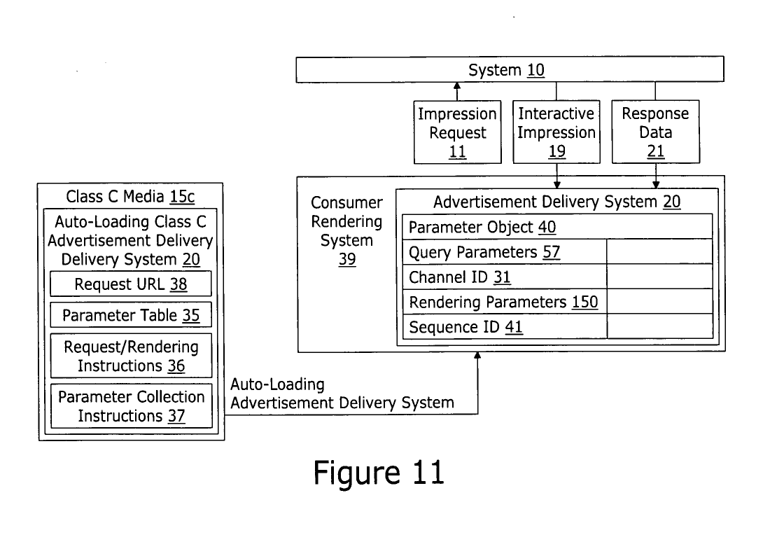

Referring to FIG. 11, Class C advertising media 15c, as previously discussed, are pulling interactive media which drive a rendering system 39 to pull an interactive advertisement impression. Providers of Class C media 15c provide an advertisement delivery system 20 which automatically loads on the rendering system. The advertisement delivery system 20 drives the rendering system 39 to generate an impression request 11 and receives an interactive impression 28 for rendering.

In one sub embodiment the advertisement delivery system 20c obtains one or more advertisement impressions 28 only at loading of the class C media 15c and for rendering of such advertisement impressions within the Class C media 15c.

For example, an email newsletter may be distributed to multiple subscribers for rendering on an email client or browser when the email is opened by a recipient consumer. The email includes the automated advertisement request system 20c which, upon opening of the email by the client rendering system causes the client rendering system to retrieve and advertisement impression 28 for rendering of its advertisement content 13 within the display of the email content.

As another example, a web page may be provided to a web browser upon the browser establishing an HTTP session with a web server. The web page may include the automated advertisement request system 20c which, upon loading by the browser, causes the browser to retrieve an advertisement impression 28 for rendering of its advertisement content 13 within the display of the web page.

In another embodiment, the advertisement delivery system 20 remains active on the consumer rendering system periodically, or upon each occurrence of an advertisement event, obtains one or more advertisement impressions 16b for rendering on the rendering system independent of the Class C media 15c.

For example, an application which periodically retrieves information from the service provider's information delivery system. For example, an application which generates a “tool bar” and/or “information bar” on a portion of a client's screen which includes information such as weather, stock prices, or other information subject to periodic change. Such application may include an implementation of the Class C advertisement delivery system 20 which remains active on the consumer rendering system periodically, or upon each occurrence of an advertisement event, obtains one or more advertisement impressions 16b for rendering on the rendering system independent of the “tool bar” and/or “information bar”.

In either embodiment, the advertisement delivery system distributed may include a parameter object 40 which includes rendering parameters 57, a channel ID 31, and optionally, format parameters 150, and a sequence ID 41. The query parameters 57, channel ID 31, and rendering parameters 150 are used for generating the impression request 11 as previously discussed.

In the example of distribution of an advertisement delivery system 20 as part of an email newsletter, exemplary query parameters 57 may identify advertisement subject matter categories related to the content of newsletter document in which the advertisement impression will be embedded, identify geographic, demographic or behavioral parameters known about the user and inserted into the table 40 by the distributor of the email (based on a subscription account to the newsletter or otherwise) and/or other query parameters useful for selecting and advertisement subject matter category meeting advertisement category selection criteria.

Exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

In the example of Class C media, the sequence ID 41 becomes an extension of the channel ID in that it is used to uniquely distinguish an advertisement delivery system 20 provided to one consumer from a system provided to another consumer. A more detailed discussion of the advantages of inclusion of a sequence ID 31 and operation of the present invention for Class C media 15c is included in U.S. patent application Ser. No. 11/236,460 filed on Sep. 27, 2005 entitled System and Method for Delivery Pay for Performance Advertising in Conjunction with Distributed Media Content. Such patent application is commonly assigned herewith and the contents of such application are hereby incorporated by reference.

In the example of distribution of an advertisement delivery system 20 as part of an application, such as a tool bar, that continually runs on the rendering system 39, the exemplary query parameters 57 may identify advertisement subject matter categories related to the content with which the consumer is currently viewings—as monitored by the application, demographic or behavioral parameters known about the user based on monitoring consumer usage of the rendering system 39 (e.g. web browsing etc), and/or other query parameters useful for selecting and advertisement subject matter category meeting advertisement category selection criteria.

Again, exemplary rendering parameters 150 may identify a file format requirement (e.g. file format of a digital file in which the advertisement content is embodied), identify required size and/or aspect ratio of the advertisement content, identify a requirement for a black and white or color advertisement content, and/or identify other rendering parameters.

Again, sequence ID 41 becomes an extension of the channel ID in that it is used to uniquely distinguish an advertisement delivery system 20 provided to one consumer form a system provided to another consumer.

Impression Request URL Format

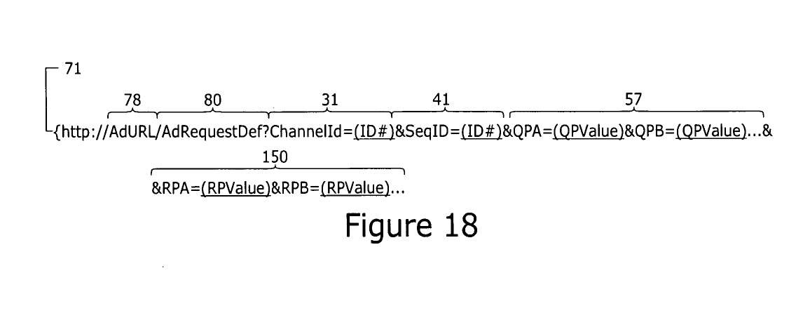

Turning briefly to FIG. 18 in conjunction with FIG. 1, an impression request 11 may be embodied in a URL 71. The URL comprises a predetermined core URL 78 associated with the system 10, a predetermined URL extension 80, the channel identifier 31, optionally, a sequence ID 41, one or more query parameters 57, and optionally, one or more rendering parameters 150.

The predetermined core URL 78 is a URL recognizable by DNS servers to facilitate routing of an HTTP connection request using the content request URL 71 to the system 10. An example of a core URL 78 would be “imagelisting.miva.com”.

The predetermined URL extension 80 is a predetermined character string which serves as an indicator to the advertisement server 22 to process the HTTP connection request as an impression request.

Impression Request by XML

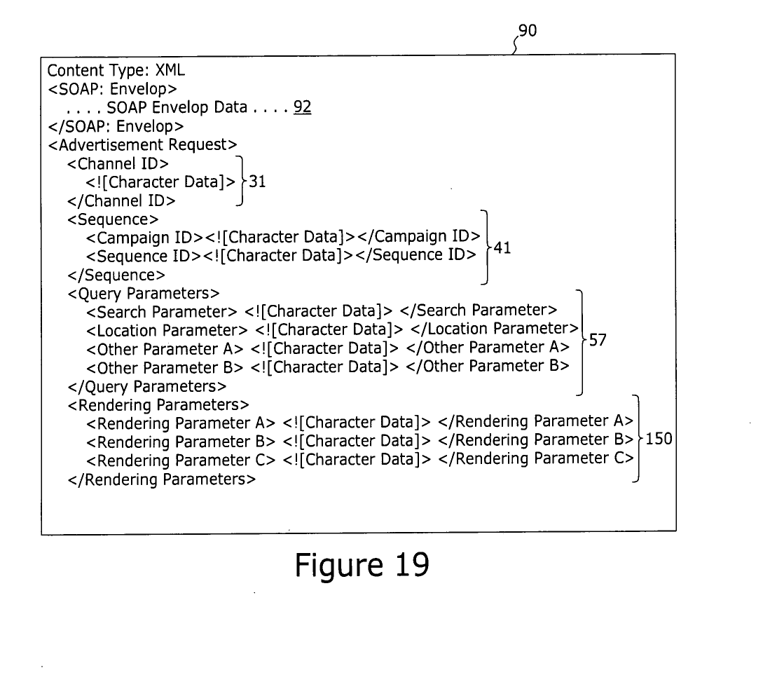

Turning briefly to FIG. 19 in conjunction with FIG. 1, an impression request 11 may be embodied in a web services or simple object access protocol (SOAP) message 90. Such a message 90 would be sent to a URL and port number of a web services server of the system 10.

The message includes, in XML format, appropriate SOAP envelop data 92 identifying the XML message as an impression request 11, the channel identifier 31, optionally, a sequence ID 41, one or more query parameters 57, and optionally, one or more rendering parameters 150.

Loading Advertisements and Auto Rendering

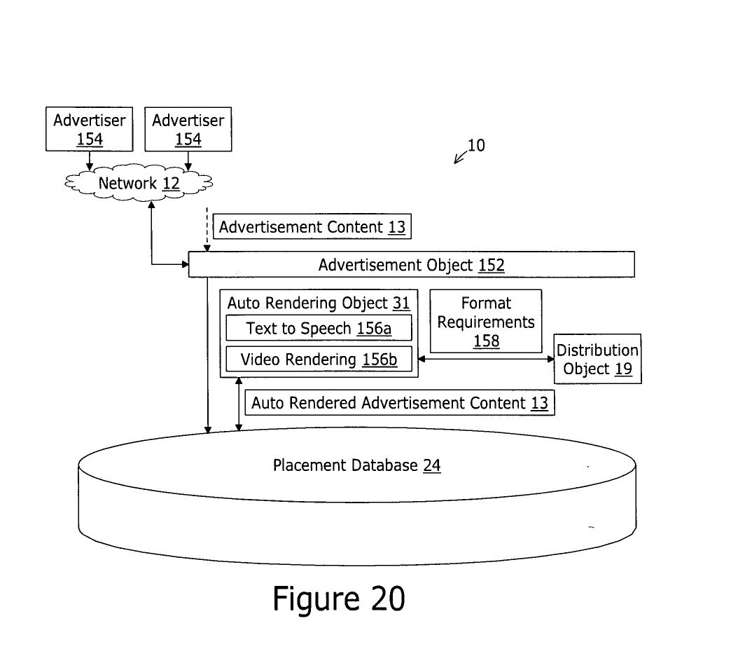

Referring to FIG. 20, a web server operates as an advertisement object 152 and provides a user interface to obtain, from each of a plurality of advertisers 154, an instance of advertisement content 13 (in multiple rendering formats), subject matter categories with which the advertisement content 13 is to be associated, the financial parameter 60 to associate with the advertisement content 13 (and the subject matter categories), and the response data 21.

However, it is also envisioned that certain rendering formats may be automatically created from advertisement content 13 provided by an advertiser. An auto rendering object 156 is coupled to the placement database 24 and may be coupled to the distribution object 19. The auto rendering object 156 receives an instance of advertisement content 13 in a first rendering format. Such instance of advertisement content 13 may be in a rendering format, such as text, provided by the advertiser 154 through the advertisement object 152. The auto rendering object 156 then generates an auto rendered instance of advertisement content 13 from the instance of advertisement content 13. The auto rendered instance of advertisement content 13 is in a second rendering format different than the rendering format of the instance of advertisement content 13.

In one embodiment, the auto rendering object 156 may further write the auto rendered instance of advertisement content 13 to the placement database 24 in association with: i) the same subject matter category as the instance of advertisement content; and ii) rendering factors associated with the rendering format of the auto rendered instance of advertisement content 13.

In another embodiment, the auto rendering object 156 receives rendering format requirements 158 from the distribution object 19 in conjunction with receiving the instance of advertisement content. In this embodiment, the auto rendering object 156 generates an auto rendered instance of advertisement content 13 that is compatible with the rendering format requirements. Such instance of advertisement content 13 is then provided to the distribution object 19 for inclusion in an advertisement impression 28 returned in response to receiving an advertisement request 11 that included rendering associated with and defining) the rendering format requirements 158.

The auto rendering object 156 may include a text to speech rendering object 156a which, in response to input of a text string portion of the instance of advertisement content 13, renders a spoken representation of the text string as an audio file. The audio file is the auto rendered instance of advertisement content 13.

The auto rendering object may include a motion video rendering object which, in response to input of a text string portion of the instance of advertisement content 13, renders motion video of an animated character performing an audio representation of the text string as a video file. Such auto performance may include speaking the text or singing a jingle. The video file is the auto rendered instance of advertisement content 13.

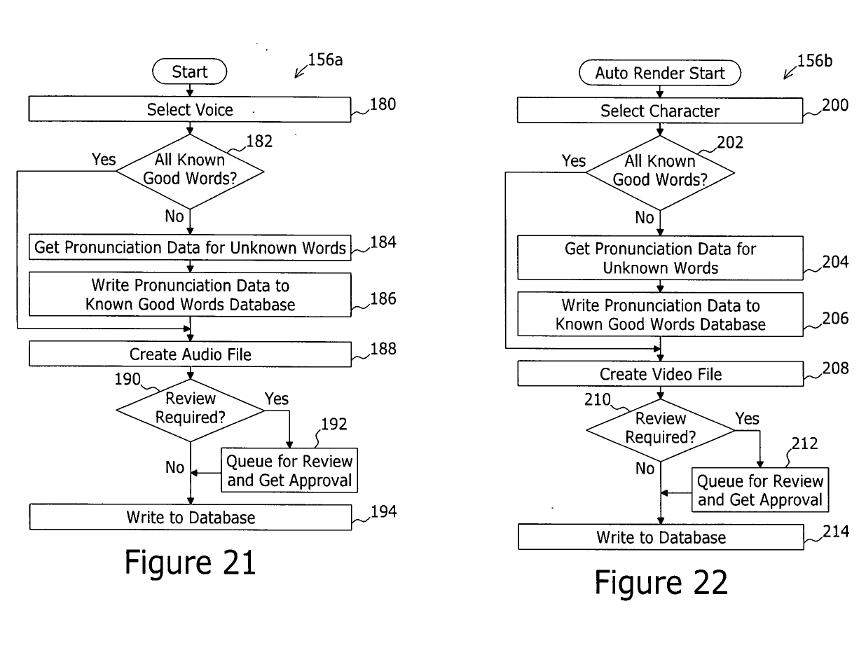

In more detail, referring to FIG. 21, an aspect of operation of the auto-rendering object 156 for auto rendering of an audio file is represented. In this aspect the audio rendering object 156 invokes operation of a text to speech object 156a to generate a spoken rendering of the instance of advertisement content 13.

Step 180 represents selecting a one of a plurality of voices to use for generating the spoken rendering. The selection of a voice may be based on any of advertisement content, past performance results using the selected voice, or other parameters such as behavioral parameters or demographic parameters known about consumers to which the auto rendered instance of advertisement content will be delivered.

If all words that are to be auto-rendered are known good words (e.g. a pronunciation exists in a known good words database), a text to speech system generates the spoken rendering at step 188.

If the text includes words not in the database, steps 184 and 186 are performed which include generating a user interface to obtain a correct pronunciation and writing the correct pronunciation of the word to the known good words database. Then, at step 188 the text to speech system generated the spoken rendering.

Step 190 represents determining whether human review is necessary. More specifically, step 190 may include comparing the auto-rendered audio file with review rules designed for calling attention to an audio file that may not appropriately rendered. For example, review rules can be based on file size, inclusion of words with multiple pronunciations—for example read (current tense) and read (past tense) or object (the noun) and object (the verb).

If review is not necessary, at step 194, the audio file is written to the database 24 or delivered to the distribution object 19 as an auto rendered instance of advertisement content 13. If review is required, the audio file is queued for review and approval is obtained at step 192 before being written to the database 24 or delivered to the distribution object 19.

In more detail, referring to FIG. 22, an aspect of operation of the auto-rendering object 156 for auto rendering of a motion video file is represented. In this aspect the audio rendering object 156 invokes operation of a text to motion video object 156b to generate a motion video representing an animated character speaking a text string of a portion of the instance of advertisement content 13, singing a jingle portion of an instance of advertisement content 13, or otherwise performing an audio representation of a portion of the instance of advertisement content 13.

Step 200 represents selecting a one of a plurality of characters (and the character's corresponding voice) to use for generating the audio/video spoken rendering. The selection of a character may be based on any of advertisement content, past performance results using the selected characters, voice, and/or other parameters such as behavioral parameters or demographic parameters known about consumers to which the auto rendered instance of advertisement content will be delivered.

If all words that are to be auto-rendered are known good words (e.g. a pronunciation and a defined motion for the character exists in a known good words database), a text to speech system generates the motion video animated rendering at step 208.

If the text includes words not in the database, steps 204 and 206 are performed which include generating a user interface to obtain a correct pronunciation and, where needed, character lip motion and writing the correct pronunciation of the word and again, where needed, the character lip motion to the known good words database. Then, at step 208 the object 156b generates the audio/video rendering of the character performing the advertisement.

Step 210 represents determining whether human review is necessary. More specifically, step 210 may include comparing the auto-rendered motion video file with review rules designed for calling attention to a motion video file that may not appropriately rendered. For example, review rules can be based on file size, inclusion of words with multiple pronunciations—for example read (current tense) and read (past tense) or object (the noun) and object (the verb).

If review is not necessary, at step 210, the motion video file is written to the database 24 or provided to the distribution object 19 as an auto rendered instance of advertisement content 13. If review is required, the motion video file is queued for review and approval is obtained at step 212 before being written to the database 24 or delivered to the distribution object 19 at step 214.

In general, it should be appreciated that the systems and methods described herein support rendering of paid advertisement content through multiple diverse general media. Although the invention has been shown and described with respect to certain exemplary embodiments, it is obvious that equivalents and modifications will occur to others skilled in the art upon the reading and understanding of the specification.

For example, those skilled in the art will appreciate that it is possible to eliminate the advertisement database by storing advertisement content in each placement table that includes the advertisement ID, however such structure would significantly increase storage requirements.

As another example, the depictions of the placement database (and other databases discussed within the specification) are for purposes of facilitating discussion of exemplary structure for the storage of data useful for implementing an embodiment of the present invention and are not intended limit the scope of the present invention. An individual skilled in the art of database design may, with an understand that the present invention, readily select alternative data storage relationships and methods for writing data to, and extracting data from, such storage relationships for performing in accordance with the present invention.

The present invention includes all such described equivalents and modifications, and is limited only by the scope of the following claims.

What is claimed is:

1. An advertisement system for providing an advertisement impression in response to each advertisement request received from each of a plurality of advertisement delivery systems, the advertisement system comprising:
a placement database storing a plurality of instances of advertisement content, each instance being stored in association with a subject matter category, rendering factors, and a financial parameter;
a distribution system coupled to the placement database for:
receiving each advertisement request, the advertisement request comprising a channel identifier and at least one query parameter, and
returning an advertisement impression that includes an instance of advertisement content that:
i) is stored in association with a subject matter category meeting selection criteria determined from the query parameters;
ii) is stored in association with rendering factors that correspond to the rendering type parameters, the rendering parameters being one of rendering parameters selected from a group of rendering parameters consisting of: i) rendering type parameters associated with the channel identifier; ii) rendering parameters included in the impression request; and iii) rendering parameters derived from the query parameters; and
iii) is stored in association with a financial parameter meeting financial parameter selection criteria, the financial parameter defining an amount payable by the advertiser upon the occurrence of an assessment event associated with rendering the instance of advertisement content.

2. The advertisement system of claim 1,
further comprising a channel database associating rendering type parameters with each of a plurality of channel identifiers; and
the distribution object returns an advertisement impression that includes an instance of advertisement content that is stored in association with rendering factors that correspond to the rendering type parameters by looking up, in the channel database, the rendering type parameters stored in association with the channel identifier of the impression request.

3. The advertisement system of claim 2,
wherein the placement database further stores, in association with each instance of advertisement content, response data defining a manner in which a consumer is to respond to the instance of advertisement content; and
the distribution object returns an advertisement impression that includes response instructions which i) are compatible with an advertisement rendering media associated with the channel identifier; and ii) direct consumer response to the instance of advertisement content as defined by the response data.

4. The advertisement system of claim 3, wherein:
the response instructions include a response object in a rendering format compatible with the advertisement rendering media; and
the response instructions include instructions for rendering of the response object upon consumer interaction with the instance of advertisement content.

5. The advertisement system of claim 3, wherein the response instructions include a URL of the advertisement system which uniquely maps to a record in a response database which includes a re-direct URL to a landing page of a web site of the advertiser.

6. The advertisement system of claim 3, wherein the response instructions include a telephone number for establishing a PSTN connection to a call center of the advertiser.

7. The advertisement system of claim 1,
the distribution object returns an advertisement impression that includes an instance of advertisement content that is stored in association with rendering factors that correspond to both i) rendering type parameters stored in association with the channel identifier of the impression request; and ii) rendering type parameters included in the impression request.

8. The advertisement system of claim 7,
wherein the placement database further stores, in association with each instance of advertisement content, response data defining a manner in which a consumer is to respond to the instance of advertisement content; and
the distribution object returns an advertisement impression that includes response instructions which i) are compatible with an advertisement rendering media associated with the channel identifier; and ii) direct consumer response to the instance of advertisement content as defined by the response data.

9. The advertisement system of claim 8, wherein:
the response instructions include a response object in a rendering format compatible with the advertisement rendering media; and
the response instructions include instructions for rendering of the response object upon consumer interaction with the instance of advertisement content.

10. The advertisement system of claim 8, wherein the response instructions include a URL of the advertisement system which uniquely maps to a record in a response database which includes a re-direct URL to a landing page of a web site of the advertiser.

11. The advertisement system of claim 9, wherein the response instructions include a telephone number for establishing a PSTN connection to a call center of the advertiser.

12. The advertisement system of claim 1,
wherein the placement database further stores, in association with each instance of advertisement content, response data defining a manner in which a consumer is to respond to the instance of advertisement content; and
the distribution object returns an advertisement impression that includes response instructions which i) are compatible with an advertisement rendering media associated with the channel identifier; and ii) direct consumer response to the instance of advertisement content as defined by the response data.

13. The advertisement system of claim 12, wherein:
the response instructions include a response object in a rendering format compatible with the advertisement rendering media; and
the response instructions include instructions for rendering of the response object upon consumer interaction with the instance of advertisement content.

14. The advertisement system of claim 12, wherein the response instructions include a URL of the advertisement system which uniquely maps to a record in a response database which includes a re-direct URL to a landing page of a web site of the advertiser.

15. The advertisement system of claim 12, wherein the response instructions include a telephone number for establishing a PSTN connection to a call center of the advertiser.

16. The advertisement system of claim 1, further comprising an auto rendering object:
receiving an instance of advertisement content; and
generating an auto rendered instance of advertisement content from the instance of advertisement content the auto rendered instance of advertisement content being in a rendering format different than the rendering format of the instance of advertisement content;

17. The advertisement system of claim 16, wherein the auto rendering object further:
defines, in the placement database, the auto rendered instance of advertisement content in association with:
the same subject matter category as the instance of advertisement content; and
rendering factors associated with the rendering format of the auto rendered instance of advertisement content.

18. The advertisement system of claim 16, wherein:
the auto rendering object includes a text to speech rendering object which, in response to input of a text string portion of the instance of advertisement content, renders a spoken representation of the text string as an audio file, the audio file being the auto rendered instance of advertisement content.

19. The advertisement system of claim 16, wherein:
the auto rendering object includes a motion video rendering object which, in response to input of a text string portion of the instance of advertisement content, renders motion video of an animated character performing an audio representation of the text string as a video file, the video file being the auto rendered instance of advertisement content.

20. The advertisement system of claim 16, wherein the auto rendering object further:
receives rendering format requirements in conjunction with receiving the instance of advertisement content;
auto rendered instance of advertisement content is compatible with the rendering format requirements;
provides the auto rendered instance of advertisement content to the distribution system for inclusion in an advertisement impression returned in response to receiving an advertisement request including rendering parameters associated with the rendering format requirements.

21. The method of claim 1, wherein, if similar instances of advertisement content, each in a different rendering format, correspond to the rendering parameters, selecting the instance of advertisement content that corresponds to both:
i) rendering parameters selected from a group of rendering parameters consisting of: a) rendering type parameters associated with the channel identifier; and b) rendering parameters included in the impression request; and
ii) additional rendering parameters derived from the query parameters.

22. A method for operating an advertisement system for providing an advertisement impression in response to each advertisement request received from each of a plurality of advertisement delivery systems, the method comprising:
storing, in a placement database storing a plurality of instances of advertisement content, each instance being stored in association with a subject matter category, rendering factors, and a financial parameter;
receiving each advertisement request, the advertisement request comprising a channel identifier and at least one query parameter, and
returning an advertisement impression that includes an instance of advertisement content that:
i) is stored in association with a subject matter category meeting selection criteria determined from the query parameters;
ii) is stored in association with rendering factors that correspond to the rendering type parameters, the rendering parameters being one of rendering parameters selected from a group of rendering parameters consisting of: i) rendering type parameters associated with the channel identifier; ii) rendering parameters included in the impression request; and iii) rendering parameters derived from the query parameters; and
iii) is stored in association with a financial parameter meeting financial parameter selection criteria, the financial parameter defining an amount payable by the advertiser upon the occurrence of an assessment event associated with rendering the instance of advertisement content.

23. The method of claim 22,
further comprising, associating, in a channel database, rendering type parameters with each of a plurality of channel identifiers; and
returning an advertisement impression that includes an instance of advertisement content comprises:
looking up, in the channel database, the rendering type parameters stored in association with the channel identifier of the impression request; and
selecting an instance of advertisement content stored in association with rendering factors that correspond to the rendering type parameters.

24. The method of claim 23,
further comprising storing, in association with each instance of advertisement content in the placement database further stores, response data defining a manner in which a consumer is to respond to the instance of advertisement content; and
returning an advertisement impression that includes an instance of advertisement content comprises returning an advertisement impression that includes response instructions which i) are compatible with an advertisement rendering media associated with the channel identifier; and ii) direct consumer response to the instance of advertisement content as defined by the response data.

25. The method of claim 24, wherein:
the response instructions include a response object in a rendering format compatible with the advertisement rendering media; and
the response instructions include instructions for rendering of the response object upon consumer interaction with the instance of advertisement content.

26. The method of claim 24, wherein the response instructions include a URL of the advertisement system which uniquely maps to a record in a response database which includes a re-direct URL to a landing page of a web site of the advertiser.

27. The method of claim 24, wherein the response instructions include a telephone number for establishing a PSTN connection to a call center of the advertiser.

28. The method of claim 22, wherein returning an advertisement impression further includes selecting an instance of advertisement content that is stored in association with rendering factors that correspond to both i) rendering type parameters stored in association with the channel identifier of the impression request; and ii) rendering type parameters included in the impression request.

29. The method of claim 28,
further comprising storing, in association with each instance of advertisement content in the placement database further stores, response data defining a manner in which a consumer is to respond to the instance of advertisement content; and
returning an advertisement impression that includes an instance of advertisement content comprises returning an advertisement impression that includes response instructions which i) are compatible with an advertisement rendering media associated with the channel identifier; and ii) direct consumer response to the instance of advertisement content as defined by the response data.

30. The method of claim 29, wherein:
the response instructions include a response object in a rendering format compatible with the advertisement rendering media; and
the response instructions include instructions for rendering of the response object upon consumer interaction with the instance of advertisement content.

31. The method of claim 29, wherein the response instructions include a URL of the advertisement system which uniquely maps to a record in a response database which includes a re-direct URL to a landing page of a web site of the advertiser.

32. The method of claim 29, wherein the response instructions include a telephone number for establishing a PSTN connection to a call center of the advertiser.

33. The method of claim 22,
further comprising storing, in association with each instance of advertisement content in the placement database further stores, response data defining a manner in which a consumer is to respond to the instance of advertisement content; and
returning an advertisement impression that includes an instance of advertisement content comprises returning an advertisement impression that includes response instructions which i) are compatible with an advertisement rendering media associated with the channel identifier; and ii) direct consumer response to the instance of advertisement content as defined by the response data.

34. The method of claim 33, wherein:
the response instructions include a response object in a rendering format compatible with the advertisement rendering media; and
the response instructions include instructions for rendering of the response object upon consumer interaction with the instance of advertisement content.

35. The method of claim 33, wherein the response instructions include a URL of the advertisement system which uniquely maps to a record in a response database which includes a re-direct URL to a landing page of a web site of the advertiser.

36. The method of claim 33, wherein the response instructions include a telephone number for establishing a PSTN connection to a call center of the advertiser.

37. The method of claim 22, further comprising an auto rendering object:
receiving an instance of advertisement content; and
generating an auto rendered instance of advertisement content from the instance of advertisement content the auto rendered instance of advertisement content being in a rendering format different than the rendering format of the instance of advertisement content;

38. The method of claim 37, wherein the auto rendering object further:
defines, in the placement database, the auto rendered instance of advertisement content in association with:
the same subject matter category as the instance of advertisement content; and
rendering factors associated with the rendering format of the auto rendered instance of advertisement content.

39. The method of claim 37, wherein:
the auto rendering object includes a text to speech rendering object which, in response to input of a text string portion of the instance of advertisement content, renders a spoken representation of the text string as an audio file, the audio file being the auto rendered instance of advertisement content.

40. The method of claim 37, wherein:
the auto rendering object includes a motion video rendering object which, in response to input of a text string portion of the instance of advertisement content, renders motion video of an animated character performing an audio representation of the text string as a video file, the video file being the auto rendered instance of advertisement content.

41. The method of claim 37, wherein the auto rendering object further:
receives rendering format requirements in conjunction with receiving the instance of advertisement content;
auto rendered instance of advertisement content is compatible with the rendering format requirements;
provides the auto rendered instance of advertisement content to the distribution system for inclusion in an advertisement impression returned in response to receiving an advertisement request including rendering parameters associated with the rendering format requirements.

42. The method of claim 22, wherein, if similar instances of advertisement content, each in a different rendering format, correspond to the rendering parameters, selecting the instance of advertisement content that corresponds to both:
i) rendering parameters selected from a group of rendering parameters consisting of: a) rendering type parameters associated with the channel identifier; and b) rendering parameters included in the impression request; and
ii) additional rendering parameters derived from the query parameters.
